(19) United States
(12) Patent Application Publication
(10) Pub. No.: US 2007/0215363 A1
(43) Pub. Date: Sep. 20, 2007

(54) Automatic Stove Top Fire Suppression Module

(76) Inventors: Royce McKim, Austin, TX (US); James Pate, Waxahachie, TX (US)

Correspondence Address: MICHAEL O. SCHEINBERG, P.O. BOX 164140, AUSTIN, TX, 78716-4140, US

(21) Appl. No.: 10/585,904

(22) PCT Filed: Jan. 14, 2004
(86) PCT No.: PCT/US04/00995

§ 371 Date: May 7, 2007

(51) Int. Cl. A62C 35/00

(52) U.S. Cl. 169/65; 169/51

(57) ABSTRACT

An apparatus for extinguishing fires in stoves used in food preparation. This invention detects a grease fire on the stovetop by detecting an elevated temperature associated with a grease fire and releases a fire suppression agent into the burning pan. A trigger mechanism retracts a restraining pin releasing the lever and cover A packet of dry fire suppression agent with a foil separator falls using gravity. The foil separator is folded in a manner that divides the fire suppression agent into smaller portions.

### CROSS-REFERENCE TO RELATED APPLICATION

| | | | |
|---|---|---|---|
| 2,030,468 | Feb. 11, 1936 | Rahlmann | 169/26 |
| 3,653,443 | Apr. 4, 1972 | Dockery | 61/61 |
| 3,773,111 | Nov. 20, 1973 | Dunn | 196/26 |
| 3,824,374 | Jul. 16, 1974 | Mayher | 169/65 |
| 4,157,526 | Jun. 5, 1979 | Davies | 337/415 |
| 4,256,181 | Mar. 17, 1981 | Searcy | 169/65 |
| 4,813,487 | Mar. 21, 1989 | Mikulec | 169/26 |
| 4,830,116 | May 16, 1989 | Walden | 169/65 |
| 4,834,188 | May 30, 1989 | Silverman | 169/65 |
| 5,186,260 A | Feb. 16, 1993 | Scofield | 169/65 |
| 5,207,276 A | May 4, 1993 | Scofield | 169/61 |
| 5,518,075 A | Mar. 26, 2002 | Padgett | 169/65 |
| 6,276,461 B1 | Aug. 21, 2001 | Stager | 169/65 |
| 6,360,825 B1 | May 21, 1996 | Williams | 169/59 |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF INVENTION

1. Field of the Invention

Apparatus for extinguishing fires in stoves used in food preparation. Grease fire is one of the main causes of serious structure fires. The purpose of this invention provides an inexpensive means of protection against grease fires on stovetop and ranges. Existing methods for controlling grease fires are either costly or with little control of the velocity at which the suppression agent contacts the burning grease, causing splashing of the burning media. The “Automatic Stove Top Fire Suppression Module” releases the fire suppression agent in several brief rapid layers resulting in a rapid extinguishing of fire and with sufficient quantity to prevent reignition. This unique delivery system is believed to be the only system that divides the dry fire suppression agent in small portions with multiple pulses controlling the decent and direction of fire suppression agent as the agent is deployed.

2. Description of Prior Art

Prior art for controlling grease fires on stoves is will noted. Prior arts for controlling grease fires are either expensive, difficult to install, unreliable, unsightly, requires additional storage or causes splashing of the burning grease. Some examples of prior art and the problems that are solved this unique invention is briefly described below.

An example of prior art is disclosed in U.S. Pat. No. 2,030,468 issued to Rahlmann. A cable system requiring attachments of pulleys and weights. Requiring extensive modifications for installation and not practical with today kitchens.

Another example of prior art is disclosed in U.S. Pat. No. 3,653,443 issued to Dockery. A system requiring experienced electrician for installation with several unsightly switches and controls.

Another example of prior art is disclosed in U.S. Pat. No. 3,824,374 issued to Mayher. A system requiring additional storage and modifications of surrounding structure for installation.

Another example of prior art is disclosed in U.S. Pat. No. 4,157,526 issued to Davies. A system of unsightly cables and pulley that is not practical for controlling stove fires and requiring extensive installation cost.

Another example of prior art is disclosed in U.S. Pat. No. 4,256,181 issued to Searcy. This system requires a modification of surrounding cabinets by drilling access holes for hoses and pipes in addition to additions storage requirements for pressure vessel.

Another example of prior art is disclosed in U.S. Pat. No. 4,813,487 issued to Mikulec. This system, although contained under the venting hood, requires several mounting points where attachments must be made. The system also requires custom configurations for different configurations of venting hoods.

Another example of prior art is disclosed in U.S. Pat. No. 4,830,116 issued to Walden. This system requires remote storage of pressure vessel and custom installation of nozzles.

Another example of prior art is disclosed in U.S. Pat. No. 4,834,188 issued to Silverman. This system requires mounting of cables and pulleys, modification of surrounding structure with access hole for piping, and additional storage for pressure vessel.

Another example of prior art is disclosed in U.S. Pat. No. 5,186,260 issued to Scofield. This system requires remote storage of pressure vessel and custom installation wiring and fuse link.

Another example of prior art is disclosed in U.S. Pat. No. 5,207,276 issued to Scofield. This system requires remote storage of pressure vessel and custom installation wiring and fuse link.

Another example of prior art is disclosed in U.S. Pat. No. 5,518,075 issued to Padgett. This is a self-contained system using and explosive device to propel a fire extinguishing powder into the burning pan. The acceleration of the fire extinguishing powder created by the explosive device increases the chances of splashing burning grease onto the surrounding stove area. Control of the direction that the powder is deployed is dependent on the rupture configuration caused by the explosive charge and not consistent.

Another example of prior art is disclosed in U.S. Pat. No. 6,276,461 issued to Stager. This is a self-contained system that is mounted to the venting hood and when a fire is detected the unit swings down and the fire suppression material is force out of an opening by a spring. The spring accelerating the fire suppression material and the possibility of large clusters of fire suppressing material striking the burning grease increases the chances for splashing burning grease onto the stovetop or surrounding area.

Another example of prior art is disclosed in U.S. Pat. No. 6,360,825 issued to Williams. This is a self-contained system that is mounted to the venting hood and when a fire is detected the unit forces a fire suppression media through an opening onto the burning fire. The forcing of a dry media through a reduce opening is unreliable due to the compaction of the dry material. Some compaction always occurs and full deployment of the dry fire suppression media is not achieved.

### BRIEF SUMMARY OF THE INVENTION

This invention is designed to be use on a stove or range with burner in line front and rear with a venting hood mounted above the burners. This invention uses magnets for installation and requires no special skill or tools for installation.

This invention stores a dry fire suppression agent above the burner in a sealed enclosure and is automatically dispensed when a fire is detected. This invention detects a grease fire on the stovetop by detecting an elevated temperature associated with a grease fire and releases a fire suppression agent into the burning pan, extinguishing the flames. Three embodiments of a trigger mechanism are disclosed and two embodiments of a foil separator are disclosed. A trigger mechanism retracts a restraining pin releasing the lever and cover. A packet of dry fire suppression agent with a foil separator falls using gravity. The foil separator is folded in a manner that divides the fire suppression agent into smaller portions. As the falling packet descends toward the burner, the foil separator distributes pulses of the dry agent alternately toward the front and rear burner. The action of unfolding the foil slows the decent rate of the dry agent and directs the dry agent in controlled manner covering both the front and rear burners with the dry agent. The dry agent has sufficient quantity causing the grease to cake or solidify preventing reignition.

### BRIEF DESCRIPTION OF THE SEVERAL VIEWS OF THE DRAWING

This document contains 14 Figures to illustrate the instillation and method of storing and deploying the fire-extinguishing agent.

FIG. 1 perspective a typical stove arrangement with two present inventions installed.

FIG. 2 is a perspective view of present invention and illustrates the first embodiment of the trigger mechanism

FIG. 3 is an exploded view of the components used in the fire extinguisher present invention first embodiment illustrating the first trigger mechanism.

FIG. 4 is an exploded view of the components used in the fire extinguisher present invention second embodiment illustrating the second trigger mechanism.

FIG. 5 is an exploded view of the components used in the fire extinguisher present invention third embodiment illustrating the third trigger mechanism.

FIG. 6 is an exploded view of the components used in the fire extinguisher present invention forth embodiment illustrating a simple melt type fuse link.

FIG. 7 is an exploded view of the components used in the fire extinguisher present invention fifth embodiment illustrating the duel cavity configuration with a simple melt type fuse link for each cavity.

FIG. 8 is an exploded view of the components of the first trigger mechanism.

FIG. 9 is an exploded view of the components of the second trigger mechanism.

FIG. 10 is an exploded view of the components of the third trigger mechanism.

FIG. 11 is a prospective view of foil separator using the cup configuration in the folded position.

FIG. 12 is a prospective view of foil separator using the cup configuration before being loaded with fire suppression agent and folded.

FIG. 13 is a prospective view of foil separator using the tube configuration in the unfolded condition.

FIG. 14 is a perspective view of present invention and illustrates the duel cavity embodiment illustrating the melt type fuse trigger.

### DETAILED DESCRIPTION OF THE INVENTION

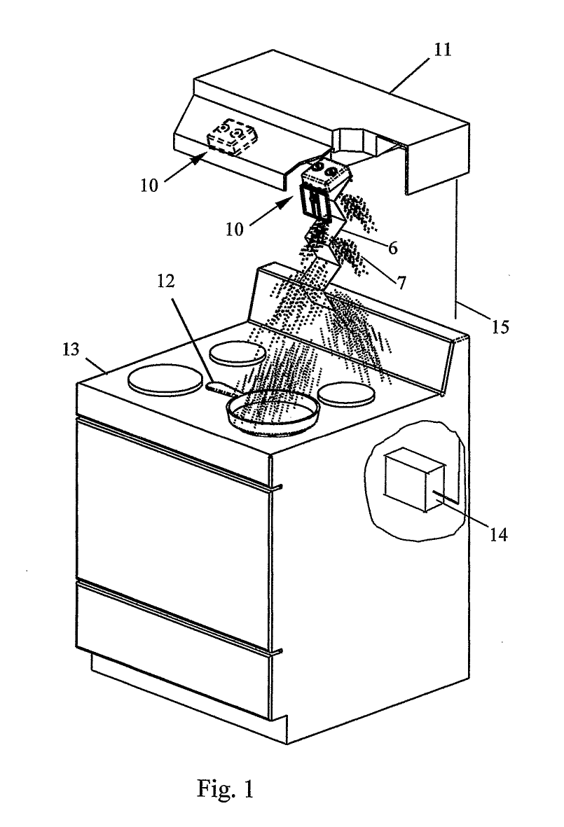

As illustrated in FIG. 1 this invention 10 mounts to the underside of 11, a venting hood, above and between the front and rear burners. When a grease fire is detected in pan 12 a dry fire suppression agent is release into to burning pan extinguishing the flames and with sufficient quantity to prevent any reignition. A novel means of releasing a dry fire suppression agent is disclosed in this invention. The dry fire suppression agent is wrapped in alternating folds of foil. When released, gravity pulls the foil and dry fire suppression agent toward the stove and as this combination of materials falls, the unfolding action of the foil divides the total of dry fire suppression agent into several smaller units. As the foil and dry fire suppression agent descends, the energy of this falling mass unfolds the foil guiding and dividing the fire suppression materials in opposite directions, and into smaller units. Short spaces are created between these units traveling toward the front burner and the unit traveling toward the rear burners. As the fire suppression agent continues toward the fire resistance of the air, combined with the updraft created by the fire, breaks up these smaller units of fire suppression agents into a cloud of fire suppression agents. This cloud settles in the areas of the front and rear burners blanketing the fire with this cloud of fire suppression agent. The fire is quickly extinguished and a sufficient quantity of fire suppression agent is deposited into the burning pan to prevent reignition.

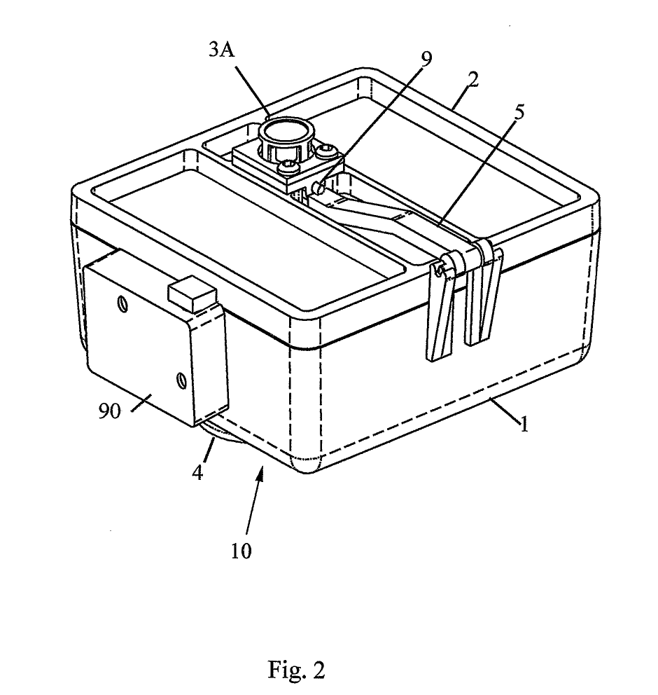

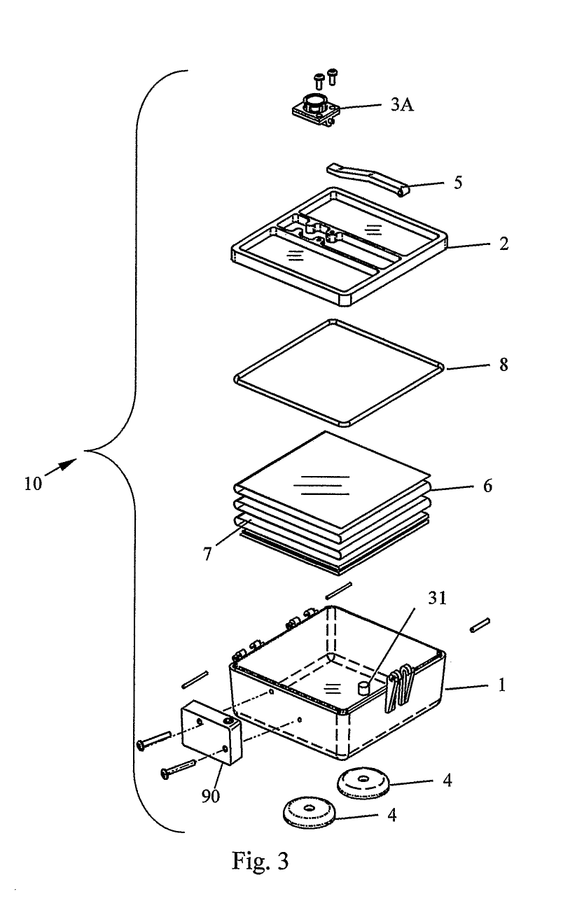

This unique method of deploying the fire suppression agent is achieved by configuring the fire suppression agent and foil in the following manner. The beginning of the foil 6 is attached the bottom of enclosure 1 by pressing the foil over the bosses 31 and secured. The fire suppression agent fills the void created by folds in the foil 6 and is illustrated as the location of fire suppression agent. A graphic representation of 7 is illustrated in FIG. 1 being deployed. A thin layer of fire suppression agent 7 is evenly distributed over the bottom surface of enclosure 1. The loose end of 6 is then folded over the first layer of 7. This front to back layering of 6 and 7 is continued until the total enclosure is filled with the fire suppression agent 7 and foil 6, as illustrated by the folded configuration of foil 6 in FIGS. 3, 4, 5, 6, 7 and 11. A seal 8 is placed between enclosure 1 and hinged cover 2. The hinged lever 5 is pressed into its stored position as illustrated in FIG. 2 and the trigger mechanism 3A is secured to cover 2 in turn securing lever. The lever applies pressure on cover to maintain sealing forces between 1, 2 and 8. The fire suppression material is now sealed from contaminants associated with the cooking and venting hood area of the kitchen.

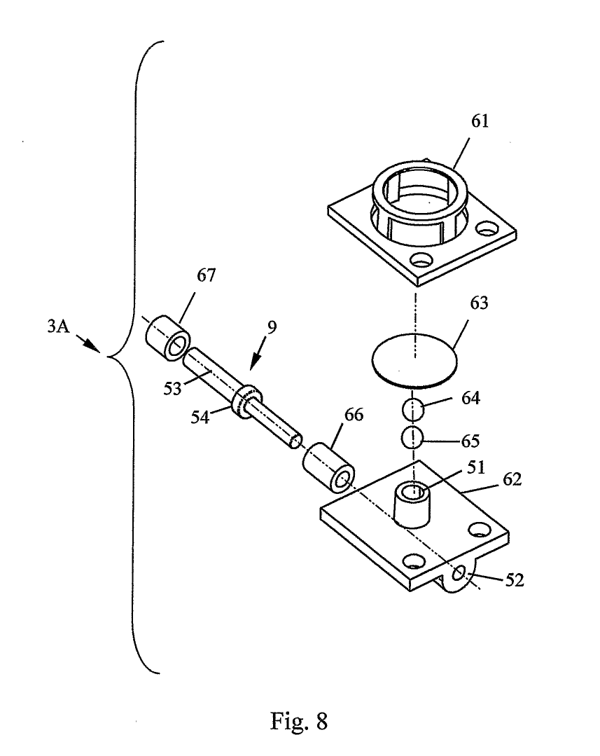

Four configurations of the trigger mechanism is will be disclosed. The first trigger mechanism 3A is illustrated in FIGS. 2, 3, and 8. FIG. 8 is an exploded view of components that make up the trigger mechanism 3A. Housing 62 FIG. 8 contains two intersecting guide holes 51 and 52. The retracting pin 9 and compression spring 66 are placed in hole 52 and retainer 67 is secured in the back of guide hole 52 as illustrated in FIG. 8. Balls 64 and 65 are placed in hole 51. Bi-metal disk 63 is placed in the cavity of cap 61. Retracting pin 9 is pushed forward to allow ball 65 to rest against shoulder 54 and surface 53 of 9. This will allow top housing 61 to rest fully against lower housing 62. This trigger mechanism can now be attached to cover 2 as illustrated in FIG. 2 with lever 5 between retracting pin 9 and cover 2. The bi-metal disk 63 is a convex disk that snaps to a concave condition when temperature rises above its designed set point. Bi-metal disk are commonly used for thermal protecting in electrical devices. A fire in the pan 12 will rapidly cause the disk 63 to rise above this set point. With the disk in the concave condition the balls 64 and 65 is forced into this space and the retracting pin is allowed to pass under ball 65 and move to its fully retracted position. The forces require to restrain the retracting pin 9 could not be achieved by the bi-metal disk directly. A mechanical advantage is cleverly achieved by placing the contact points of the ball 65 at an angle that reduces the forces on the bi-metal disk 63 while retaining sufficient force to displace the balls 64 and 65 when no longer secured by bi-metal disk 63. To reduce the time require to heat bi-metal disk 63 past its set-point, the disk 63 has been placed facing the heat source, fire in pan 12. Additionally venting to the backside of the disk has been allowed for by openings cap 61 and the thermal path to the mass of the other components of the system has been reduced. The combination of features disclosed in this paragraph yields a sensor that is activated only when the extreme temperatures of a grease fire is detected and greatly reduces the chances of false activation.

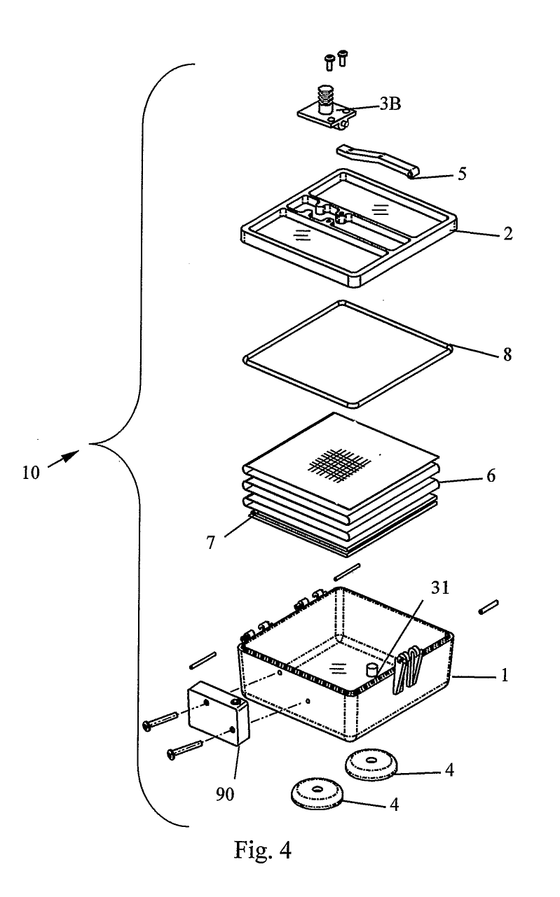

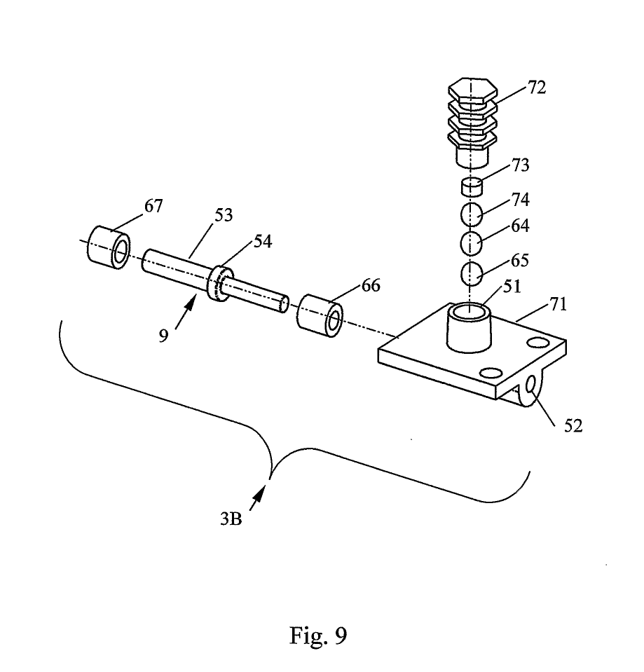

The second trigger mechanism 3B is illustrated in FIGS. 4, and 9. FIG. 9 is an exploded view of the vertical trigger mechanism 3B and illustrates the components. Similarly as in trigger mechanism 3A, trigger mechanism 3B uses several common components and the action unique to 3B will be disclosed. An additional ball 74 was added to achieve greater height and decrease the thermal path to the housing 71. The bi-metal disk 63 and top housing 61 is replaced by a fusible link 73 and cap 72. Cap 72 is designed to achieve rapid heating of fusible link. When exposed to the extreme temperatures of a grease fire, fuse 73 melts at its melt point temperature and the balls 74, 64, and 65 are allowed to move toward the cap 72 displacing the melted fuse. The release action is the same as in 3A described earlier. Fins located on the cap 72 furnish a larger area for heat to be transfered into cap 72 and to the fuse 73. The wall sections have been reduced to reduce the thermal path to the mass of the other components. The mechanical advantage achieved through the contact angle of ball, as described in trigger mechanism 3A, allows the fuse 73 to be reduced in size and also allows the fuse to reach melt temperature quickly. The melted fuse material is contained within the housing.

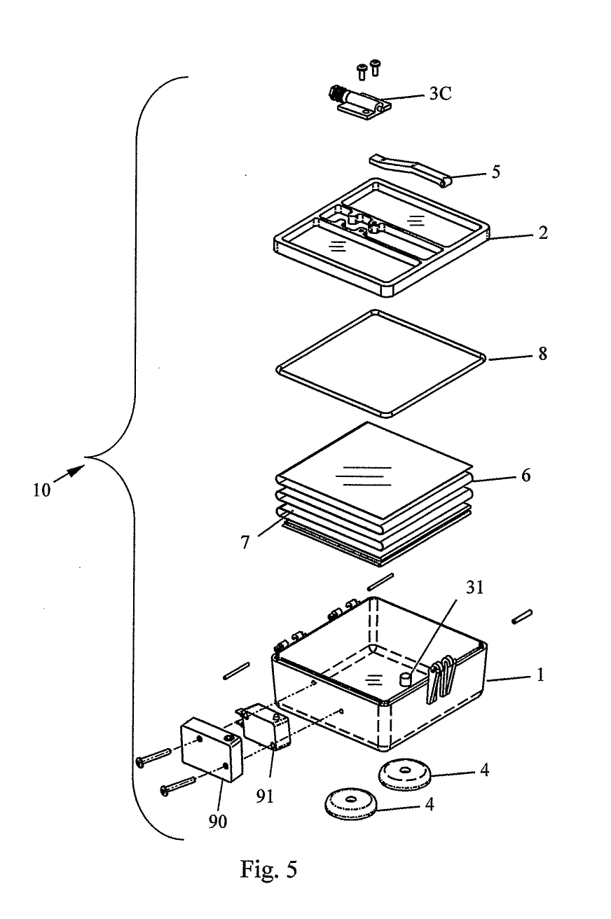

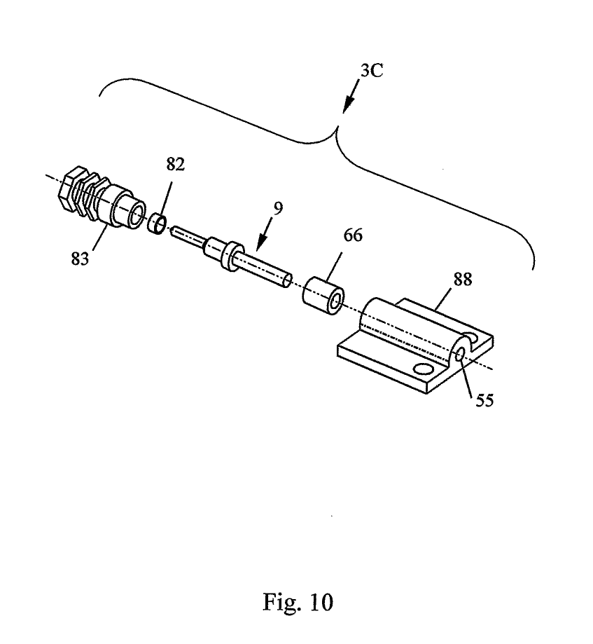

The third trigger mechanism 3C is illustrated in FIGS. 5, and 10. FIG. 10 is an exploded view of the third trigger mechanism 3C and illustrates the components. This configuration is a direct approach to retracting pin 9. Housing 80 has a guide hole 55 for retracting pin 9, compression spring 66, and cap 83. Fuse 82 is seated in cap 83 and components 9, 66, and 82 are held in housing 88 by cap 83. The spring 66 applies retracting forces to retracting pin 9. Fuse 82 restrains the movement of the pin 9 until it reaches its melt temperature, at that point, pin 9 displaces the melted material and is fully retracted.

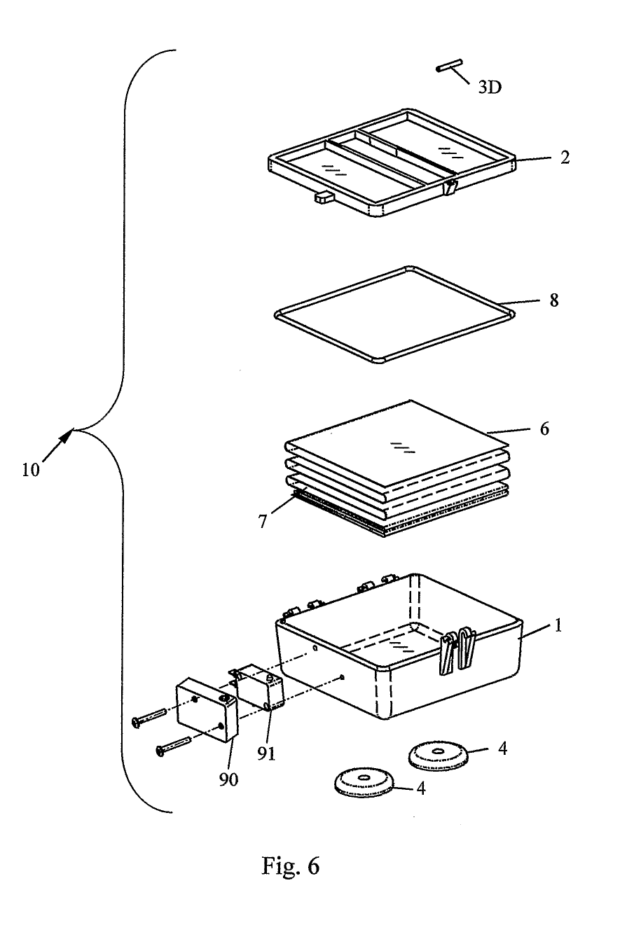

The forth trigger mechanism 3D is illustrated in FIGS. 6, 7, and 14. The latch holder is a pinned hinge arrangement. A fuse material in the form of a pin 143 is used as the latch holder of cover 141 to the latch holder of the enclosure 142. When the fuse is melted, the cover 141 is allowed to fall open releasing the combination of foil 6 and fire suppression agent 7. The deploying of these components is as described previously. In another embodiment of the latch holder is in the configuration in the form of a flat strip with one of its ends secured to enclosure 142 and its other end secured to the cover 5.

Having fully disclosed the actions of the four configurations of the trigger mechanisms 3A, 3B, and 3C clamed in this invention, the following action occurs after the retracting pin 9 is fully retracted. Lever 5, maintaining sealing pressure between the housing 1, the cover 2, and the seal 8 is released, compression forces of the seal 8 combined with gravity and the weight of fire suppression agent 7, forces the said lever 5 and cover 2 to it fully open position. Gravity action on the fire suppression material 7 and foil 6 pulls these components towards the stove 13. As these components descend, the energy of the falling components unfolds the foil 6 guiding and dividing the fire suppression materials 7 in opposite directions, and divides the fire suppression agent into smaller units. Short spaces are created between this unit traveling toward the front burner and the unit traveling toward the rear burners. As the fire suppression agent continues toward the fire, resistance of the air combined with the updraft created by the fire, these smaller units of fire suppression agents are feather separated creating a cascade of fine fire suppression agent fragments which quickly extinguishes the fire and a sufficient quantity of fire suppression agent is added to the burning pan to prevent reignition.

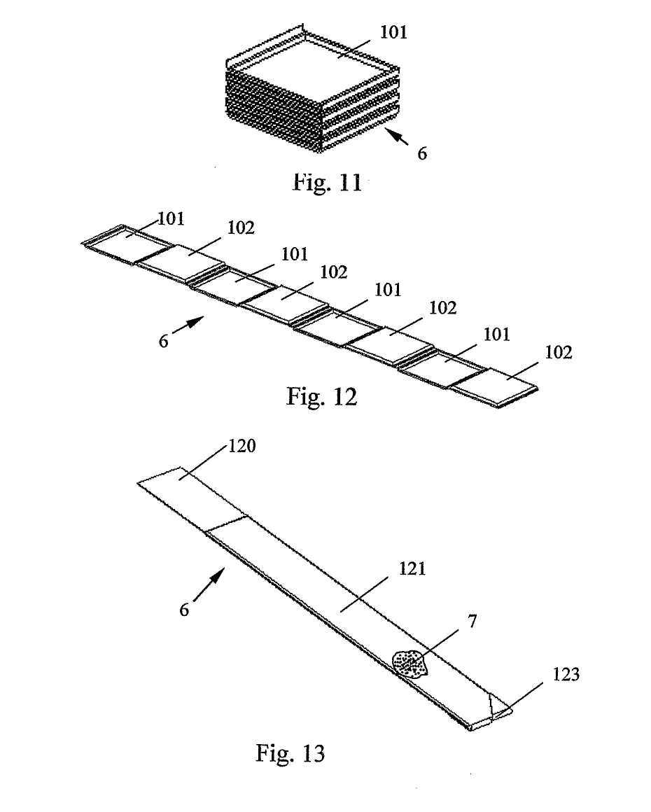

Another embodiment of the foil 6 illustrated in FIG. 11 and FIG. 12 is made up a formed sheet of foil where depressing are form in the foil in an alternating pattern. Depressions 101 would contain the fire suppression material to be dispensed in one direction and depressions 102 would hold fire suppression material to be dispensed in the opposite direction. The foil and fire suppression is folded forming a configuration as illustrated in FIG. 11.

Another embodiment of the foil 6 is illustrated in FIG. 13 contain either single or more than one pocket folded into the foil forming a tube. In this embodiment of the invention 10 the invention 10 is placed directly over the pan 12. The fire suppression agent 7 is placed inside the tube in a thin layer. The foil tube is closed by folding the end foil 123 over the open end of formed tube. This is then folded or rolled along section with agent 121 to a size that fit the inside of closure 1 and section 120 is attached to enclosure 1. When deployed the tube unrolls. After unrolling the energy of the falling fire suppression agent unfolds the end of the foil depositing the dry fire suppression agent into the burning pan.

An additional feature, illustrated in FIGS. 2-6, that enhances the appeal of this invention is a micro switch 91 and switch cover 90 activated by closing of cover 2 allows for a low voltage interface 15 between this invention and automatic cut-off devices 14. When activated this switch send a signal to these devices to remove the energy source to the stove. These controls are required for insurance discounts in some areas.

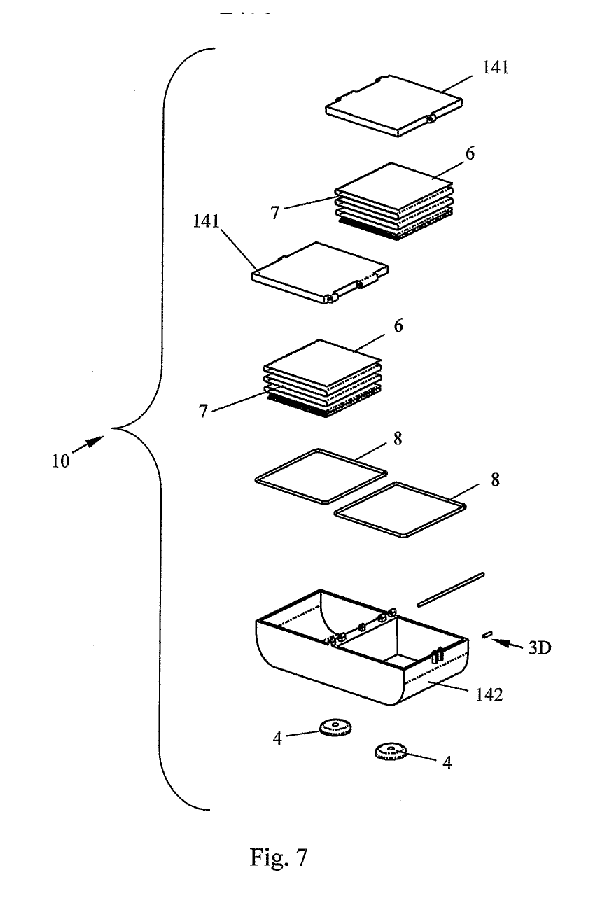

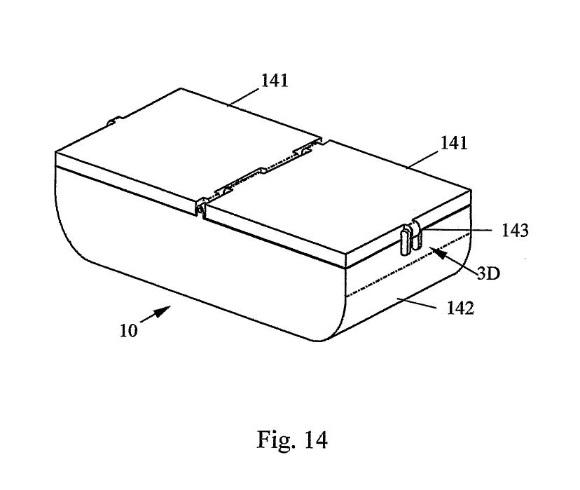

Another embodiment of the invention 10 is made up of a container with two cavities and release triggers as illustrated in FIG. 7 and FIG. 14. This duel system gives additional security with redundant systems for all operations. The operation of this configuration is as described previously.

While the invention has been particularly shown and described with reference to an embodiment thereof, it will be understood by those skilled in the art that various changes in form and detail may be made without departing from the spirit and scope of the invention.

We claim:

1. An automatic fire extinguisher module for stove grease fires consisting of:
an enclosure means having a surrounding wall forming at least one cavity and said cavity having a top and bottom and a base substantially perpendicular to said walls covering top of said cavity,
at least one cover means for substantially sealing said bottom of said enclosure,
a mount means for securing said enclosure above said stove,
a hinge means interposed between said enclosure and said cover for unsealing and opening said enclosure,
at least one dry fire suppression agent means stored internal to said enclosure in sufficient quantities for extinguishing a fire and preventing reingintion,
a foil separator means having two ends where said first end is fastened interior to said enclosure and where second end is interspersed in said suppression agent for controlling the decent and direction of deployment of said agent,
a thermally actuated trigger means for releasing said cover and to allow said cover to swing open and out of the path of said agent.

2. The invention according to claim 1 wherein said trigger means consist of the following;
a thermally absorptive housing having a first and second hole intersecting at substantially right angles where said first hole is bored through,
a latch retracting pin means slidingly mounted inside said first hole for releasing said cover and breaking said enclosure seal,
a latch hold means for clasping around said retracting pin is mounted on said enclosure means,
a shoulder means mounted on said pin for cocking said pin in locked position,
a spring means interposed between said housing and said pin and drivingly connected to said housing and said pin for moving said pin to the release position and away from said latch hold means,
a first and second ball means slidingly mounted interior to said second hole wherein said first ball means contacts said pin shoulder for placing a force on said first ball that directs said first ball away from said pin,
a thermally actuated means mounted in said housing for holding said first and said second ball against said pin shoulder and to provide axial movement away from said pin at a predesigned temperature,
said second ball means for axial movement and force transmission to said disk mounted in said second housing hole and interposed between and drivingly connected to said thermally actuated means and said first ball.

3. The invention according to claim 2 wherein said thermally actuated means consist of a bimetallic disk that moves from original position to new position directionally away from said pin at a predesigned temperature.

4. The invention according to claim 2 wherein said thermally actuated means consist of eutectic material that melts and gives way for displacement of said first and send balls directionally away from said pin at a predesigned temperature.

5. The invention according to claim 1 wherein said trigger means consists of;
a thermally absorptive housing having a blind hole,
a latch retracting pin means slidingly mounted inside said first hole for releasing said cover,
a latch hold means for clasping around said retracting pin is mounted to said enclosure means,
a spring means interposed between said housing and said pin and drivingly connected to said housing and said pin for moving said pin to the release position and away from said latch hold means,
a eutectic material means mounted in said housing hole and interposed between and drivingly connected to said housing and said pin for holding said pin and to provide axial movement away from said pin by melting at a predesigned temperature,

6. The invention according to claim 1 wherein said latch hold means consist of the following;
a hinge means mounted to said enclosure,
a lever means with two ends wherein the first end is rotationally mounted on said hinge means and said second lever end is interposed between said retracting pin and said cover for providing sufficient force on said cover to effectively seal said enclosure.

7. The invention of claim 1 wherein said foil consist of at least one foil sheet means substantially circumscribed by said enclosure wall for distributing said agent on said fire.

8. The invention according to claim 1 wherein said foil consist of;
a plurality of foil sheet means for efficiently delivering said agent wherein said sheets are stored interior to said enclosure substantially parallel to each other and said cover with a substantially equal amount of said agent interspersed between said sheets,
a plurality of hinge means mounted for limited rotation and said hinge means singularly interposed between a pair of said sheets forming a continuous chain of said sheets and said hinges and when deployed from said enclosure said sheets and said hinges form a zig-zag pattern.

9. The invention according to claim 8 wherein said foil sheet means are mesh screen means for allowing passage of some of said agent through said screen to improve distribution on said fire for open cover deployment.

10. The invention according to claim 1 wherein said foil means consist of at least one pocket means mounted on said foil means wherein said foil means is an elongated strip having two ends where first end is mounted interior to said enclosure and said pockets consist of an essentially flexible four-sided material wherein three of said sides fasten to said foil and said fourth side remains unfastened and farthest away of said four sides to said foil first end and said pocket is filled with said agent.

11. The invention according to claim 1 wherein said mount means consist of at least one magnet means for mounting to metal objects.

12. The invention according to claim 1 wherein said enclosure contains a pliable seal to substantially seal the interface between said cover and said enclosure.

13. The invention according to claim 1 wherein a system for turning off energy to stove upon activation of said release pin opening said cover of said enclosure comprising;
an electrical micro switch means mounted exterior to said enclosure and adjacent to said cover and activated by said cover swinging open,
a stove energy control means and a wire electrically connecting said switch and said energy control means.

14. A fire extinguisher unit comprising:
a hollow cupped closure base having a first and second side and a top and bottom wherein said closure having a bottom opening having a perimeter that is substantially planar and placed above and substantially directed toward a fire,
a hinge attached to said first side such that the axis of rotation is substantially parallel with plane of said opening,
a cover rotationally attached to said hinge and in at least one rotational disposition substantially enclosing said cupped closure,
a trigger mechanism wherein;
a eutectic fuse pin having an axis disposed substantially parallel with said opening plane and said pin having a first and second end,
said first end is partially encircled by said closure second side and coaxially disposed and partially encircled by said cover closure
and disposed in thermal communication with said fire,
a flexible sheet having a first and second end where said first end is fastened interior to said hollow cupped closure base and said sheet is disposed substantially parallel to said opening perimeter plane,
a fire suppression agent interposed between at least said flexible sheet and said hollow cupped closure base.

15. A fire extinguisher unit as in claim 14 whereby;
heat from said fire causes said eutectic fuse pin to melt releasing said cover to rotationally swing around said hinge axis;
said fire suppression agent stored between said sheet and said closure base pressing down on said sheet causes unrestrained said second sheet end to swing down allowing said agent to flow onto said fire.

16. A fire extinguisher unit as in claim 14 wherein said flexible sheet is comprised of;
a plurality of said flexible sheets having a substantially planar surface,
a plurality of rotationally limited hinges interposed between said second sheet end and said first end and the successive said sheets and said hinges fastened similary and deployed out of said closure having a maximum included angle between said sheet and said opening perimeter plane of less than sixty degrees wherein said succesive said sheets and hinges form a zig-zag pattern and said plurality of sheets and hinges store substantially parallel to each other occupying no greater planar area than interior most said flexible sheet,

17. A fire extinguisher unit as in claims 14 and 16 wherein said fire suppression agent is interposed between said plurality of sheets,

18. A fire extinguisher unit as in claim 14 wherein said trigger mechanism comprises;
a housing with an interior hole rigidly mounted to said closure cover,
a pin slidingly mounted in said bearing block along axis,
a spring axially interposed and drivingly connected to said block and said pin,
